(19) United States
(12) Patent Application Publication
(10) Pub. No.: US 2005/0273361 A1
(43) Pub. Date: Dec. 8, 2005

(54) System and a method for an audit and virtual case management of a business and/or its components

(76) Inventor: Rebecca S. Busch, Oak Brook, IL (US)

Correspondence Address: MCANDREWS HELD & MALLOY, LTD, 500 WEST MADISON STREET, SUITE 3400, CHICAGO, IL, 60661, US

(21) Appl. No.: 11/140,260

(22) Filed: May 27, 2005

Related U.S. Application Data
(62) Division of application No. 09/713,619, filed on Nov. 15, 2000.

(51) Int. Cl. G06F 17/60

(52) U.S. Cl. 705/2

(57) ABSTRACT

The present invention provides a system and a method for an audit of a business and/or its components. More specifically, a formula is provided that may track errors in a health care business, such as financial, department specific, and/or clinical/medical. The errors may be coded and categorized by persons other than patient care providers. Further, the present invention provides a method for identifying, qualifying, quantifying, coding, categorizing, prediction and/or mitigation of errors on a concurrent basis through, for example, point of service audits. The errors and information may be gathered during the audits and may be entered into a database. Data mining may be implemented to provide additional information in which flowcharts may be created to be used as a case management tool.

### CROSS-REFERENCE TO RELATED APPLICATIONS

This application is a divisional of application Ser. No. 09/713,619 filed Nov. 15, 2000, titled “A System and a Method For an Audit and Virtual Case Management of a Business and/or Its Components,” which is incorporated herein by reference in its entirety.

### BACKGROUND OF THE INVENTION

The present invention generally relates to a system and a method for an audit of a business and/or its components. The present invention further relates to a system and method for monitoring, auditing, mitigating, categorizing, predicting and/or tracking of clinical/medical and/or financial errors that may be made by a business. Still further, the present invention provides a system and a method for using the clinical/medical and/or financial errors as a case management tool.

It is, of course, generally known to conduct audits of financial transactions within a company, such as a hospital. In addition most hospitals and/or other healthcare providers have some type of case management program that may evaluate limited aspects of clinical/medical care of a patient or may target specific diagnostic groups. Such programs, however, fail to manage day-to-day patient revenues and/or ongoing market changes or the like which is prevalent in the health care industry. In addition, such programs, merely audit financial transactions after the patient has been treated and discharged.

In addition, it is generally known for health care personnel to manage the health of patients as well as the financial costs associated with caring for the patient.

The combined responsibility of healthcare professionals to manage patients both clinically/medically and financially is a fundamental cause of inefficiencies that exist in health care. For example, a nurse often is required to perform multiple tasks. Three commonly required tasks are to administer a service to a patient, to document what service was given to the patient, and then to charge the cost associated with administering the service to the patient. The nurse may assign administering the service to the patient as a top priority, documenting the type of service administered to the patient as a second priority, and give the lowest priority to charging the cost of the task to the patient.

In addition, health care providers must stay current on the latest diagnostic technology as well as the complex financial structure and/or relationships with insurance companies and/or regulatory requirements. If a health care provider does not stay current on payor rules, the health care provider may not get paid and may often be fined. A payor is any person or entity who is responsible for payment of healthcare services. A payor may be private, such as an insurance company, or may be public, such as Medicare and Medicaid, or may be the patient receiving the health care.

A need, therefore, exists for a system and a method for auditing the records of a health care facility that does not involve caretakers of a patient but personnel trained specifically to be familiar with the business subject matter and ongoing market changes; as well as a method and system for auditing a business, such as a health care facility, from the moment a patient enters the facility on a day-to-day basis.

To this end, the present invention provides a system and a method for identifying, qualifying, quantifying, coding, categorizing, prediction and/or mitigation of errors and/or subsequent methodology updates. The coding, categorizing, prediction and/or mitigation of errors are fundamental and unique processes for analyzing financial and clinical/medical deficiencies within health care facilities. More specifically, the present invention provides a formula that tracks three types of errors in a health care business: financial, department specific, and clinical/medical. Further, the identifying, qualifying, quantifying, coding, categorizing, prediction and/or mitigation of errors are not performed by patient care providers. Still further, the method for identifying, qualifying, quantifying, coding, categorizing, prediction and/or mitigation of errors is conducted on a concurrent basis through point of service audits. Still further, the data generated from the audits may be used as a case management tool.

### BRIEF SUMMARY OF THE INVENTION

The present invention provides a system and a method for an audit of a business and/or its components. More specifically, a formula is provided that tracks three types of errors in a health care business financial, department specific, and clinical/medical. Data mining of errors may be used as a case management tool. The errors may be coded and may be categorized by persons other than patient care providers. Further, the present invention provides a method for identifying, qualifying, quantifying, coding, categorizing, prediction and/or mitigation of errors on a concurrent basis through point of service audits.

To this end, in an embodiment of the present invention a method is provided for training personnel to audit a business at a location where a transaction occurs and the location is associated with the business. The method is comprised of the steps of choosing personnel to audit the business and training the personnel to collect data, to audit records as the records are created, and to visually audit the transaction of the business.

In an embodiment of the present invention, the personnel are trained to audit records by comparison to sources for documenting the business and the personnel are trained to identify any irregular activity that is not documented.

In an embodiment of the present invention, the personnel are trained to evaluate the effectiveness of the audit of the business and to design efficient auditing procedures for the business. The personnel are also trained to communicate with clients, to conduct a retrospective analysis of the business, to collect relevant data, and to enter data into a database.

In another embodiment of the present invention, a method is provided for auditing of a business at a location where a transaction occurs. The location is associated with the business. The method is comprised of the steps of conducting a general audit of the business, entering information collected during the general audit into a database, data mining information collected from the general audit, prioritizing an area in which a significant error occurs and establishing a specification code for each function of the business. The specification code is used to create an auditing chart. Additional steps of the method are comprised of choosing a pilot area associated with the area in which the significant error occurs, testing the auditing chart in the pilot area, auditing the pilot area with the auditing chart at the location of the transaction, collecting information during the auditing of the pilot area and modifying the auditing of the business on-site based on the information collected in the pilot area. Further, the specification code and the auditing chart are updated and the pilot area is audited with the updated specification code and the auditing chart.

In an embodiment, the auditing is on a day-to-day basis and data is entered on a day-to-day basis.

In an embodiment, clinical/medical records, financial records, and activities that are not documented are audited.

In an embodiment, a second area and/or subsequent areas associated with an area in which a significant error occurs may be chosen. The second area is audited with a auditing chart at the location of the transaction. Information is collected during the auditing of the second area. The business is modified and audited on-site based on the information collected in the second area. Further, specification code and the auditing chart are updated based on the information collected in the second area and the second area is then audited with the updated specification code and the updated auditing chart.

In another embodiment of the present invention, a method for virtual case management of a business is provided. The method is comprised of the step of conducting a continuous audit of a process to identify process errors associated with the business. The method is further comprised of the steps of collecting errors from the continuous audit, entering the errors into a database, data mining the errors in the database, creating a flowchart from the data mining, creating a case management tool from the flowcharts and mitigating the errors with the case management tool.

In an embodiment the errors include clinical/medical errors, financial errors and department errors.

In another embodiment of the present invention a system for an audit of a business is provided. The system is comprised of personnel associated with the audit of the business, a specification code created by personnel for a function of the business, an auditing chart created with the specification code, and a database wherein information associated with an error from the audit of the business is stored and the error is mined. Further, a pilot area of the business is provided to test the auditing chart.

In another embodiment of the present invention a system for virtual case management of a business is provided. The system is comprises of a continuous audit of a process to identify process errors associated with the business. The system is further comprised of a database wherein the errors from the continuous audit are mined. Still further a flowchart associated with the errors mined is provided and a case management tool created from the flowcharts is provided.

It is, therefore, an advantage of the present invention to provide a system and a method to identify clinical/medical errors to reduce financial risks to a facility.

Another advantage of the present invention is to provide a system and a method to identify financial errors to increase revenue and cash flow of a business while decreasing inefficiencies in clinical/medical records, in the business office, in specific department areas, and/or decrease exposure to fines.

And, another advantage of the present invention is to provide a system and a method to improve data accuracy for a cost accounting system.

Yet another advantage of the present invention is to provide a system and a method to improve data collection used for payor contract negotiations.

A further advantage of the present invention is to provide a system and a method to improve operational deficiencies.

A still further advantage of the present invention is to provide a system and a method to improve patient satisfaction.

Another advantage of the present invention is to provide a system and a method to recover lost revenue.

And, another advantage of the present invention is to provide a system and a method to correct operational errors that may adversely affect the health care provider.

A further advantage of the present invention is to provide a system and a method to mitigate and/or track clinical/medical errors.

A still further advantage of the present invention is to provide a system and a method to decrease internal waste in a business.

Another advantage of the present invention is to provide a system and a method to mitigate potential denials from payors such as an insurance company.

And, another advantage of the present invention is to provide a system and a method that increases economic value for health care providers and for users of the system.

Moreover, an advantage of the present invention is to provide a system and a method for virtual case management of a business and/or its components.

Another advantage of the present invention is to provide a system and a method to automate management of health care episodes.

And, another advantage of the present invention is to provide a system and a method that provides a cost effective tool for case management of a business and its components.

A further advantage of the present invention is to provide a system and a method to facilitate a decision-making process, reduce errors, improve outcomes, and provide access to resources.

Additional features and advantages of the present invention are described in, and will be apparent from, the detailed description of the presently preferred embodiments and from the drawings.

### BRIEF DESCRIPTION OF SEVERAL VIEWS OF THE DRAWINGS

FIG. 1 illustrates a flowchart of an embodiment of a system of the present invention wherein a patient is admitted and/or registered in a hospital.

FIG. 2 illustrates a flowchart of an embodiment of a system and a method of the present invention for training, conducting a retrospective analysis and/or on-site modification of an auditing method.

FIG. 3 illustrates a flowchart of an embodiment of a system and a method of the present invention for defining initial specifications.

FIG. 4 illustrates an accounting chart in an embodiment of the present invention.

FIG. 5 illustrates a flowchart of an embodiment of a virtual case management method and system of the present invention.

### DETAILED DESCRIPTION OF THE INVENTION

The present invention provides a system and a method for tracking errors in a health care business. More specifically, the present invention relates to a system and a method for tracking financial, department specific, and/or clinical/medical errors. The errors may be coded and/or categorized by persons other than patient care providers. The present invention further provides a method for identifying, coding, and/or quantifying errors on a concurrent basis.

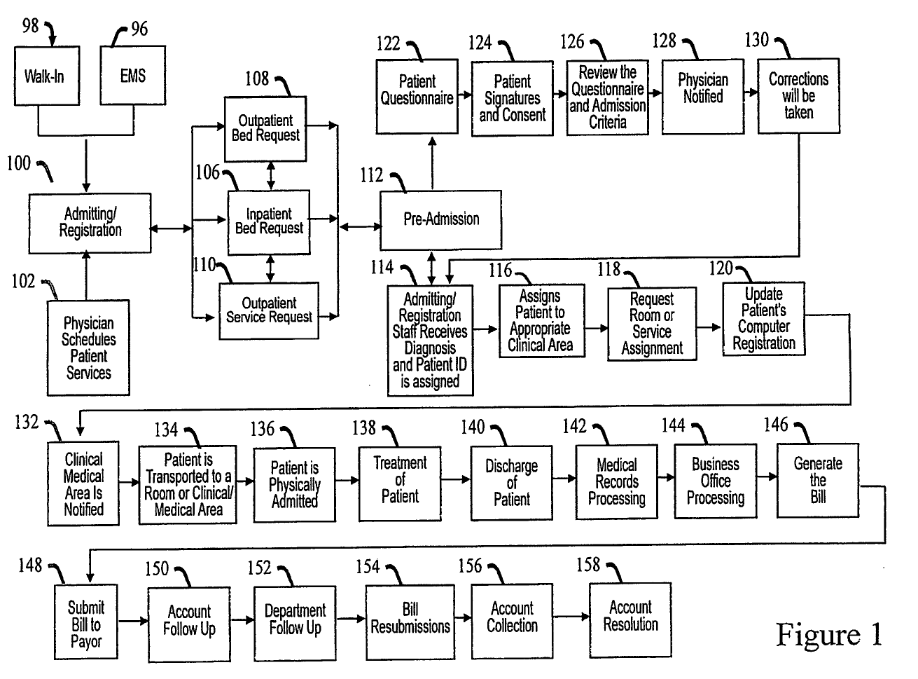

Referring now to the drawings wherein like numerals refer to like parts, in FIG. 1, a flowchart generally illustrates steps that may be performed before a health care provider receives payment for services. The system and method of the present invention works within this structure. For example, for a healthcare provider, such as a hospital, the revenue process may begin when a patient is admitted into a hospital, as shown at the admitting/registration step 100. The patient, for example, may enter the hospital, for example, as a walk-in 98, through emergency medical services (EMS) 96 or the patient may be referred by a physician. When a physician refers a patient to a hospital, the physician calls the hospital and schedules services for the patient as shown at step 102.

During the admitting/registration process as shown at step 100, the patient may be admitted or an outpatient may be registered. If the medical doctor of the patient is not known, a medical doctor may be assigned to the patient and computer registration may be initiated. After the patient completes the admitting/registration step 100, the patient or the physician may make an in patient bed request as shown at step 106, an out patient bed request as shown at step 108, or an out patient service request as shown at step 110. These types of bed requests or service requests may change. For example, a patient may start as an out patient and later may make an in patient bed request as shown at step 106. A common error that may occur at this step is that a provider, such as a hospital or doctor, or a payor, such as an insurance company, may incorrectly designate a benefit plan to the patient. The next step is pre-admission as shown at step 112.

During the pre-admission step 112, the admitting/registration staff receives a diagnosis of the patient and a patient identification may be assigned as shown at step 114. The patient identification may include an account number and a clinical/medical record number. The patient may then be given a patient identification bracelet to wear. The admitting/registration staff may then assign the patient to the appropriate clinical/medical area as shown at step 116 and request a room or service assignment as shown at step 118 from, for example, a nurse. At this point, the admitting department may update the patient's computer registration as shown at step 120.

When a patient enters the hospital on his own accord or via emergency medical services (EMS) as shown at step 96, at the pre-admission step 112, the patient may be asked to fill out a patient questionnaire as shown at step 122 and patient signatures and consent may be obtained as shown at step 124. Typically, a nurse may then review the questionnaire and admission criteria as shown at step 126. Based on the review, if any admission issues exists, a nurse may notify a physician as shown at step 128, and any necessary corrections may be taken as shown at step 130. At this point, the admitting/registration staff may receive the diagnosis of the patient, and the patient identification is assigned as shown at step 114. The admitting/registration staff may then assign the patient to the appropriate clinical/medical area as shown at step 116 and then may request a room or service assignment as shown at step 118 from, for example, a nurse. At this point, the admitting department may update the computer registration of the patient as shown at step 120.

After the admitting department updates the computer registration of the patient as shown at step 120, the appropriate clinical/medical area may be notified as shown at step 132 and the patient may be transported to a room or clinical/medical area as shown at step 134. Finally, the patient may be physically admitted as identified at step 136.

During this common method of admitting a patient in a healthcare facility, such as a hospital, common clinical/medical and financial errors may occur. For example, from a financial view, a patient may have been admitted by insufficient admission criteria, with incorrect insurance information, and improper insurer notification. From a clinical/medical view, the patient may have been admitted with an incorrectly designated benefit plan, with insufficient or incorrect clinical/medical data or lack of data, inefficient coordination of resources, and lack of easy access to disease management programs and benefit plan programs.

The patient has entered a complex system of healthcare providers and insurers who are dependent on data received during the admission process in addition to data received during care of the patient in making decisions with respect to the care and reimbursement of services for that patient. The wrong data may be applied to the wrong patient, and abnormal and normal diagnostic information may not be passed on to the correct patient.

After the patient is physically admitted as shown at step 136, the treatment of the patient as shown at step 138 may occur prior to discharge of the patient as shown at step 140. Following discharge of the patient as shown at step 140, clinical/medical records processing shown at step 142 and business office processing shown at step 144 may generate the bill of the patient as shown at step 146 and then may submit the bill to payor as shown at step 148. The payor is the insurance company or patient or whomever was designated as the paying party for the healthcare services rendered.

After the healthcare provider has submitted the bill to the payor as shown at step 148, the healthcare provider may conduct an account follow up as shown at step 150 and department follow up as shown at step 152 to ensure the provider has received the bill and to ensure no outstanding issues exist. At this point, if any changes were made, bill resubmissions may occur as shown at step 154. The next step is account collection as shown at step 156, and finally, account resolution as shown at step 158.

A bill may not be submitted until an extended time period after the discharge of a patient due to efforts required to identify or correct any deficiencies within the file of a patient. After the discharge of the patient, professional staff, clinical/medical records department, business office, and the admitting department may need to correct a single problem. Another common error is that the patient may be discharged without appropriate follow up arrangements and/or post-care prevention and management. In addition, these types of errors often result in lost revenue and increased clinical/medical and financial risk to the health care facility.

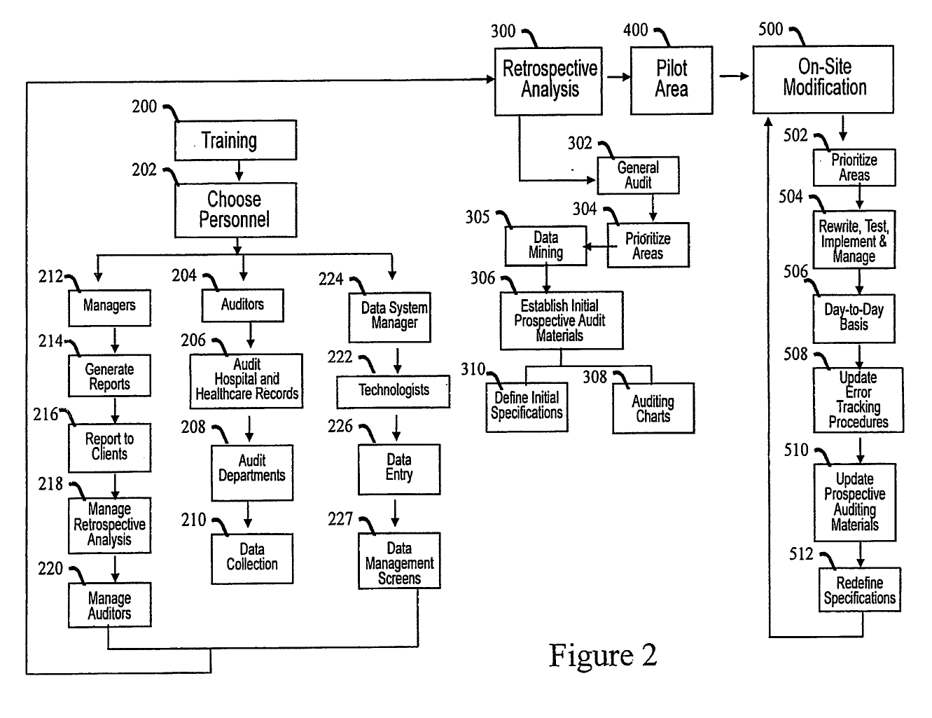

The flowchart of FIG. 2 generally illustrates a system and a method for training, conducting a retrospective analysis, and/or on-site modification of an auditing method that may be applied to the general structure illustrated in FIG. 1. The first step of the audit is training as shown at step 200. For the training step 200, the appropriate personnel may be chosen as shown at step 202. In the preferred embodiment, there are three types of personnel: managers 212, auditors 204, and technologists 222. Auditors 204 may be registered nurses; healthcare professionals; and others with an understanding of clinical/medical terminology, health clinics, and provider operations such as hospitals and clinics. Auditors 204 may be trained to audit hospital and healthcare records as shown at step 206 by comparison to onsite visual audits, financial data, the hospital's charge master, hospital operating procedures, and any other current sources for documenting patient care.

Auditors 204 may also audit departments within the healthcare facility as shown at step 208. Auditors 204 may begin auditing and data collection at the bedside of a patient in specific departments such as outpatient areas or general medical floors of a hospital as shown at step 210. These areas may be chosen first for newly trained auditors 204 because they are typically less complex than other areas of the hospital. More complex areas such as, for example, the operating room or labor and delivery, are audited by auditors 204 with more advanced training. In addition to auditing records, the auditors 204 may have the opportunity to note any irregular or erroneous activity in the patient or department area in which they may be located. Hence, the auditors 204 are not only noting financial and clinical/medical errors in reports, they may also note financial and clinical/medical errors that may not be documented anywhere.

Managers 212 may be trained to generate reports to evaluate the effectiveness of an audit of the facility in question and to design efficient auditing procedures for the facility in question as shown at step 214. The managers 212 may also receive training in communication with clients as shown at step 216. Further, the managers 212 may be trained to manage a retrospective analysis of a healthcare provider, such as a hospital, as shown at step 218. In addition, the managers 212 may manage auditors 204 as shown at step 220.

The technologists 222 may be managed by the data system manager 224 and may be trained in data entry as shown at step 220. The technologists 222 may be trained to receive the information provided by the auditors 204 and/or the managers 212 and enter the information into a known computer database.

After the auditors 204, the managers 212, and the technologists 222 are trained, a retrospective analysis 300 may be conducted by the managers 212 and the data systems manager 224. The managers 212 may conduct a general audit of different areas of the healthcare facility or business, such as a hospital, as shown at step 302. The technologists 222 may enter the information gathered during the general audit 302 into data management screens as shown at step 227. The managers 212 and the data systems manager 224 may review the information and then may prioritize areas that appear to generate the most significant number of errors as shown at step 304.

The managers 212 may be trained to evaluate revenue reports, exception reports, late charge reports, external and internal operational deficiency reports, business office reports, registration/admitting reports, census reports, health information management reports, the hospital's current charge master, current internal codes for cost centers and revenue departments, current floor plan of patient care areas, internal management reports that note delinquent charges, number of denials from insurance companies, number of accounts written off to bad debt, number of audits from insurance companies, number of audits from public aid, number of audits from Medicare, list of current managers, current financial statements, sample of current bills and respective clinical/medical records, onsite physical audit of key hospital functions from the point of patient entry to discharge, current clinical/medical records' procedures, transcription procedures, and hospital policy and procedures including charge capture and credit policies.

After the managers 212 and the data systems manager 224 have completed a retrospective analysis as shown at step 300, the managers 212 may establish initial prospective audit materials as shown at step 306 in which the managers 212 may define initial specifications as shown at step 310 and create auditing charts as shown at step 308. Information received during the retrospective analysis 300 may be used to select benchmarking materials, criteria and establish a baseline for the auditing charts as shown at step 308.

The managers 212 may then select a pilot area as shown at step 400 within the healthcare facility in which to test the auditing charts. The auditors 204 may then begin an audit of the pilot area as shown at step 400 by auditing clinical/medical records at the patient bedside on a day-to-day basis. The auditors 204 may evaluate all functions in the pilot area that impact revenue, including functions that are not typically documented in any record. For each function, a custom data management screen may be designed by the managers 212 to record errors and any subsequent changes in procedure as shown at step 227. The data collected may be compared to the revenue report of the healthcare facility to note any subsequent financial changes since the implementation of the audit. Additional steps taken during the audit are described below in further detail.

Based on the data collected and onsite auditing, the auditors 204 may begin to note any other activity that impacts the healthcare facility financially. The managers 212 may conduct on-site modification of the audits as shown at step 500. The managers 212 may prioritize areas as shown at step 502. The managers 212 may choose the area with the highest priority as the pilot area 400 and then may add additional areas. The managers 212 may then rewrite, test, implement and manage new procedures for those activities as shown at step 504. The procedure used during the audit that detects the financial errors for the facility may continually be updated as the auditors 204 continue to note activities that financially impact the healthcare facility as shown at step 508 and update prospective auditing materials as shown at step 510. The managers 212 may track the procedures used and errors detected on a day-to-day basis as shown at step 506 and report such information in the management reports. The managers 212 may continue the on-site modification as shown at step 500 by redefining specifications as shown at step 512 and then repeating the on-site modification as shown at step 500.

Clinical/medical errors that may be outside the scope of revenue management may be brought to the attention of the appropriate healthcare facility contact. For example, if the incorrect medication was documented as given to a patient, this clinical/medical error may be outside the scope of the financial audit. Even though this method does not present a solution or a new procedure to correct this type of clinical/medical error, all clinical/medical errors may be noted and may be brought to the attention of the appropriate healthcare facility contact person.

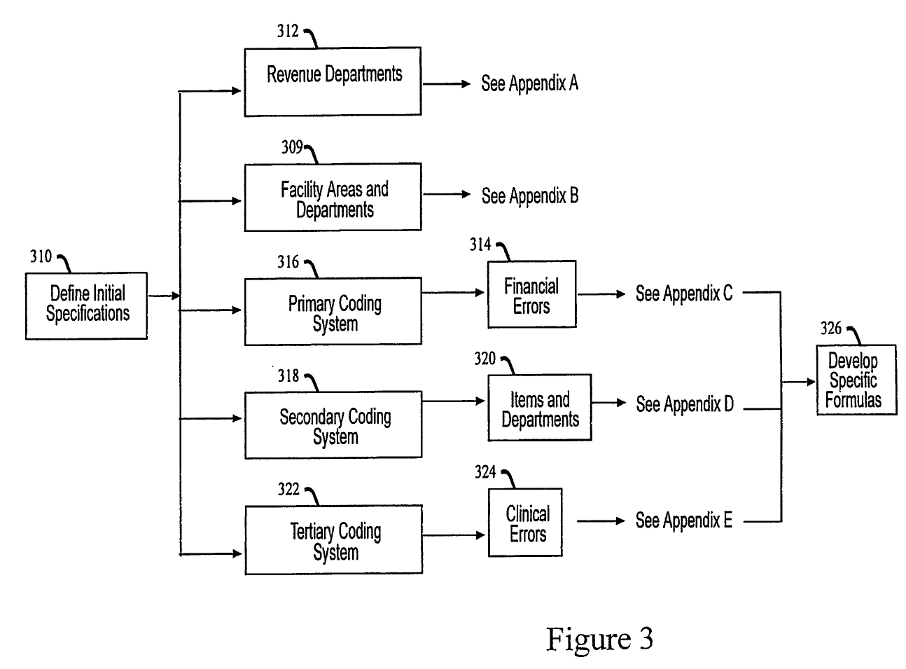

Turning now to FIG. 3, the specific steps taken by the auditors 204 and the managers 210 are illustrated. The managers 210 may define initial specifications 310 by assigning a code to each facility area and department of the healthcare facility as shown at step 309. For example, in a hospital setting, the pharmacy department may be assigned a department code 2, and the outpatient department may be assigned a department code 5. For a sample list of codes that may be assigned to facility areas and departments in a hospital setting as shown at step 309, see Appendix B. Further, the managers 212 may assign a code to all revenue departments in the healthcare facility as shown at step 312. For example, in a hospital setting, the nursery department may be given a description “NUR” and a revenue code number “25” by the hospital, but the managers 212 may assign their own code such as “16”. For a sample list of codes that may be assigned to revenue departments of a hospital as shown at step 312, see Appendix A.

After the managers 212 have assigned codes to facility areas and departments as shown at step 309 and revenue departments as shown at step 312, a letter code may be assigned to different financial errors as shown at step 314 under a primary coding system as shown at step 316. For example, “Admitting/Registration Errors” may be assigned the letter “N”, “Item indicated on the charge sheet but not supported by documentation in the designated area In the medical record” may be assigned the letter “B”, and “Other” may be assigned the letter “F”. An exemplary list of codes that may be assigned to common financial errors as shown at step 314 from the primary coding system as shown at step 316 is attached as Appendix C.

Further, in a Secondary Coding System as shown at step 318, codes may be assigned to specific items and departments as shown at step 320. For example, “Day Surgery” may be assigned the letters “DS”. For a sample list of codes assigned to items and departments as shown at step 320 from the Secondary Coding System as shown at step 318, see Appendix D.

Still further, in the Tertiary Coding System as shown at step 322, codes may be assigned to specific clinical/medical errors as shown at step 324. All discovered clinical/medical errors may be referred to the appropriate contact person at the healthcare facility. For example, “Incomplete documentation of services” may be assigned the code “AAI”; “Omitted or delayed medication” may be assigned the code “EE2”; and “Missing MD signatures” may be assigned the code “HH3”. For a sample list of codes that may be assigned to clinical/medical errors as shown at step 324 from the Tertiary Coding System as shown at step 322, see Appendix E.

After the departments, areas, items, and type of errors have been coded, the managers 212 may develop specific formulas as shown at step 326 for the auditing charts as shown at step 308. Each unique area of the healthcare facility may have its own auditing chart.

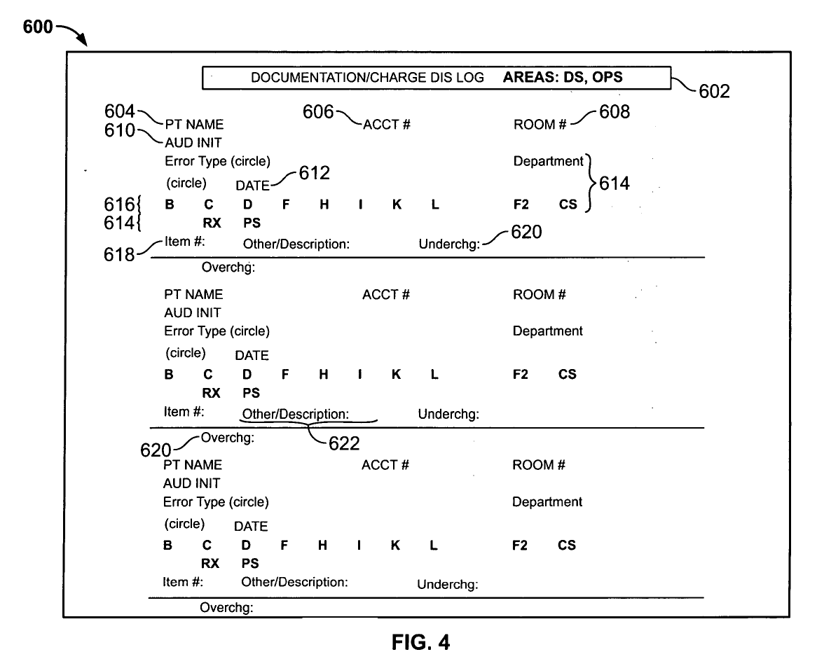

Areas that have similar operating procedures and share the same type of errors may share an auditing chart. For example, FIG. 4 illustrates a chart 600 for the areas of day surgery and for out patient surgery. The codes for the specific areas 602 are shown in the upper right hand corner. An area is provided in which to write in the patient's name 604, account number 606, room number 608, the auditor's initials 610, and the date 612. An area is also provided where the auditor 204 may circle the code for the appropriate department 614. An area is further provided where the auditor 204 may circle the code that represents the error 616 that may be detected. In this example, the codes B, C, D, F, H, I, K, L are shown as choices. The auditor 204 may also have the option of writing in any code not shown under other/description 622. In addition, the auditors 204 may note the department in which the error occurred. FIG. 4 shows the codes F2, CS, RX, and PS as typical departments 614 where errors most commonly occur. Again, the auditor 204 may not be limited to the codes shown and may write in another code. In addition, the chart may also allow for the entry of information regarding the specific item 618 in question and the amount undercharged or overcharged 620.

The codes shown are selected during the retrospective analysis of the area as shown at step 300. At that time, the managers 212 may note what errors most commonly occur and in which departments the errors occur. The managers 212 and the data systems manager 224 may use data mining as shown at step 305 to retrieve the relevant information the managers 212 are seeking. Data mining may include the extraction of implicit, previously unknown, and potentially useful information from data. Data mining may use machine learning, statistical and visualization techniques to discovery and present knowledge in a form which may be easily comprehensible to humans. The managers 212 corroborate with the data systems manager 224 in retrieving information from the database created by the data entry of the audits that may be continuously conducted and entered into the database. Using data mining, the errors may be brought to the attention of the managers 212, and the managers 212 may then take the next step to assist in correcting and mitigating the errors.

As the auditors 204 continue to audit the area and the managers 212 continue to change or update procedures due to the common errors that may be found, the auditing charts, as shown at step 308, may also by changed. For example, after the auditing charts as shown at step 308 may be given to the technologist 222 for data entry 226, the managers 212 may generate a report and note that most of the errors occurred in the department coded RX. The code RX may refer to the pharmacy. After the pharmacy is established as a department that is executing errors, a new procedure may be created, tested, and/or implemented in the pharmacy department. After additional audits, additional changes may or may not be necessary.

The managers 212 may continually evaluate the audits, generate reports, change procedures and audit charts on a day-to-day basis. The process of continually evaluating the audits, generating reports, changing procedures and auditing charts on a day-to-day basis, allows for the discovery of errors and correction of individual errors as well as improvements on financial and clinical/medical procedures prior to discharge of patients. In addition to continually changing and updating procedures due to the common errors that may be found, the managers 212 may also continue to update the training for the auditors 204, the data system managers 224 and the technologists 222 as well as update the specifications as shown at step 310, update the prospective audit materials as shown at step 510, update the data management screens as shown at step 227, continue to conduct retrospective analysis as shown at step 300 and/or test within a pilot area as shown at step 400.

After patients are discharged, the auditors 204 may also audit the existing process used by the healthcare facility as shown in FIG. 1 in the generation of bills as shown at step 146, account follow up as shown at step 150, account collection as shown at step 156 and/or other potential billing errors. The managers 212 may also implement a new procedure at this later stage. The managers 212, the auditors 204, the data systems manager 224 and the technologists 222 may conduct audits on a day-to-day concurrent basis from a time the patient enters the healthcare facility until a time at which the patient is discharged, including steps along the way. Further, audits will also be conducted during the process of generating the bill of the patient and every step taken until the bill is settled.

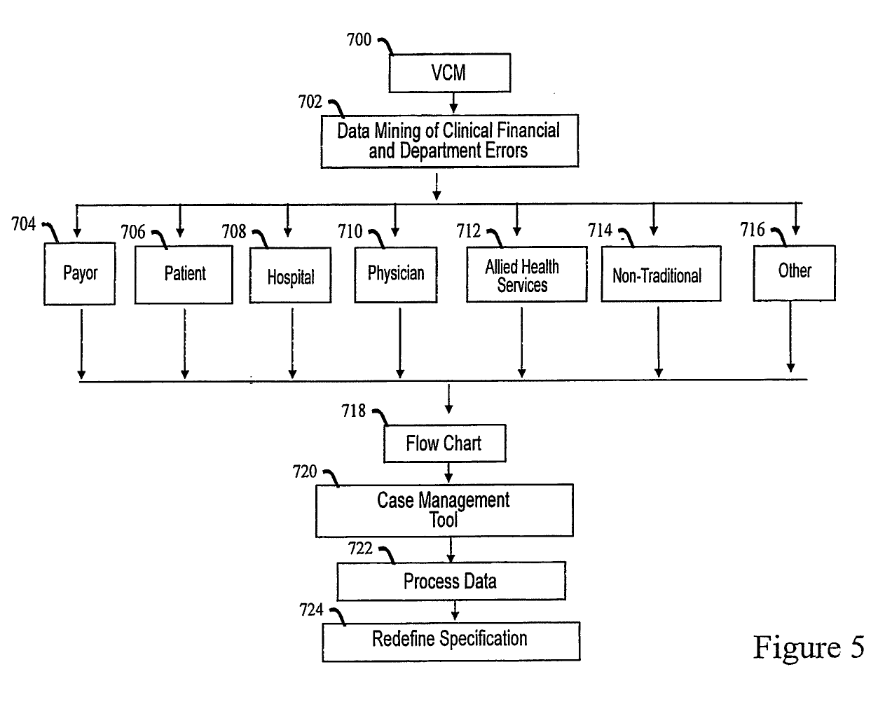

In addition to using the data mining as shown at step 305 for the day-to-day point of service auditing of financial and/or clinical/medical errors in a healthcare facility, the data mining as shown at step 305 may be used as a virtual case management tool as shown in step 700 in FIG. 5. As discussed previously, data mining may be used in the auditing of financial and/or clinical/medical errors. In addition, the data mining as shown at step 702 may be used in virtual case management (VCM) analysis as shown at step 700 to audit, for example, the errors of a healthcare facility, such as errors of a hospital or a doctor, patient errors, and payor errors. VCM is a decision making analysis tool that may enable the financial and clinical/medical method for identifying, qualifying, quantifying, coding, categorizing, prediction and/or mitigation of errors in current and ongoing management of healthcare services.

The VCM method 700 may begin by collecting error transaction data during defining specifications as shown at step 310 of FIG. 3 and as described above. Data mining of clinical/medical, financial and department errors may be provided as shown at step 702 in the fields of payor 704, patient 706, hospital 708, physician 710, allied-health 712, non-traditional 714, and other 716. The data mining that may occur from the specification process feeds into flowcharts for each field as shown at step 718. The flowcharts may create an automated case management tool as shown at step 720. The next step is to process data on self-management of current and future health products and services with reimbursement schedules for each field as shown at step 722. This information may then be used to redefine specifications as shown at step 724.

The VCM tool as shown at step 700 may provide the user with a decision making tool to self-manage resources, direct resources, and/or select options to mitigate potential and/or actual transaction errors. The tracking of current errors into a decision-making tool process may limit, avoid, and/or minimize future errors in the decision-making and management process of an episode of health care. The foundation of the process is built on existing errors. As the errors are addressed, the present invention may provide for the continuous addition of new and future errors for eventual management, mitigation and/or resolution.

As additional data may be fed through the system, additional VCM tools may be developed. In the preferred embodiment, tools include: VCM-hospital, VCM-physician, VCM-patients, VCM-payors, VCM-allied health, VCM-nontraditional providers, and VCM-other businesses.

More specifically, VCM of a payor 704 may allow the payor 704 to look for duplicate billings, management of future services and/or any other payment criteria including the method for identifying, qualifying, quantifying, coding, categorizing, prediction and/or mitigation of errors.

VCM of a patient 706 may allow the patient 706 (or employers with insured employees) to seek and/or manage the selection process and/or management of services within a network and/or out of a network and also allow for the identifying, qualifying, quantifying, coding, categorizing, prediction and/or mitigation of errors. For example, if the patient 706 has a hip replacement, the logistics of managing the selection of rehabilitation services for non-covered and covered services may be manual and/or disconnected in the market place. VCM 700 of a patient 706 may address this issue.

VCM of a hospital 708 may allow the hospital 708 to manage future services and reimbursement issues after the patient leaves healthcare facility and allows for the management of identifying, qualifying, quantifying, coding, categorizing, prediction and/or mitigation of errors. For example, if the hospital 708 performs a hip replacement surgery on a patient, the hospital 708 may lose the opportunity to present rehabilitation services upon discharge because the logistics of managing post-operative care and general subsequent care may be complex and cumbersome. The logistics of managing post-operative care and general subsequent care is a manual process and generally is disconnected in the market place. The present invention may allow for an automated post discharge case management tool that addresses this issue.

VCM of a physician 710 may allow physicians 710 to manage future services and reimbursement issues after they determine a patient's diagnosis and treatment plan in addition to identifying, qualifying, quantifying, coding, categorizing, prediction and/or mitigation of errors. For example, a physician 710 may diagnose a patient with a severe arthritic condition of the hip and may recommend a total hip replacement. The physician 710 may not proceed with the plan of care without coordination of other players in the market place. The Payor 704 may decide to pay for only three days of rehabilitation, for example, but the plan of the physician 710 of care requires seven days of rehabilitation for an optimal outcome. Surgery may be placed on hold until the entire care plan may be facilitated and/or coordinated. The present invention addresses this issue by providing coordination of approved services and options to facilitate and/or finance non-covered services.

VCM of allied health services 712 may allow allied health services to manage the identifying, qualifying, quantifying, coding, categorizing, prediction and/or mitigation of errors, services and/or reimbursement issues. For example, a patient 706 may have a total hip replacement. The insurance coverage of the patient 706 may allow for in-home physical therapy. Automated knowledge of this information may allow the physical therapist a opportunity to manage these patients.

VCM of non-traditional health services 714 may allow non-traditional health services 714 to manage the identifying, qualifying, quantifying, coding, categorizing, prediction and/or mitigation of errors and/or reimbursement issues. For example, a patient 706 may have a total hip replacement. The policy coverage of the patient 706 may provide for some limited chiropractic rehabilitation services, or acupuncture for pain management, for example. The present invention may assist non-traditional health providers to manage these patients 706.

VCM of other business services 716 may allow other businesses outside of hospitals to manage services, policy requirements, and/or reimbursement issues as well as the identifying, qualifying, quantifying, coding, categorizing, prediction and/or mitigation of errors. Other businesses services 716 may include a nursing home, for example, that temporarily discharges a patient 706 to a hospital for a total hip replacement. After discharge, the nursing home may not have the facility to directly manage the rehabilitation process. Therefore, the logistics of finding interim care and lodging for the patient 706 may be manual, cumbersome, and/or limited. Other business services 716 may also include a school system that may manage health records of children within a school district. The process of maintaining certain health requirements may often be manual, cumbersome and/or limited. The present invention may facilitate these issues.

It should be understood that various changes and modifications to the presently preferred embodiments described herein may be apparent to those skilled in the art. Such changes and modifications may be made without departing from the spirit and scope of the present invention and without diminishing its attendant advantages. It is, therefore, intended that such changes and modifications be covered by the appended claims.

### Appendix A

### Codes for Revenue Departments

| Code | | | |
|---|---|---|---|
| Assigned | Hospital | Hospital In-house | Hospital |
| by | In-house | Text Description of | In-house |
| Managers | Description | Area of Hospital | Rev Code |
| 1 | M2 | Med II | 18 |
| 2 | M1 | Med I | 15 |
| 3 | S1 | Surg 1 | 13 |
| 4 | ICU | ICU | 21 |
| 5 | IMC | IMC | 14 |
| 6 | TLC | TLC | 20 |
| 7 | LD | L & D | 33 |
| 8 | END | Endoscopy | 43 |
| 9 | DS | Day Surg | 39 |
| 10 | OPS | OP Surg | 30 |
| 11 | CVI | CVI | 23 |
| 12 | OR | OR | 31 |
| 13 | IV | IV Therapy | 42 |
| 14 | CS | Central Supply | 34 |
| 15 | MS | Material System | 71 |
| 16 | NUR | Nursery | 25 |
| 17 | OBG | Obstetrics | 24 |
| 18 | OPT | Out Patient | 46 |
| 19 | PMC | Pain Management | 75 |
| 20 | HEMO | HemoDialysis | 85 |
| 21 | ER | Emergency Room | 36 |
| 22 | PHM | Pharmacy | 69 |
| 23 | PS | Pulmonary | 67 |
| 24 | RR | Recovery Room | 32 |
| 25 | AP | Anatomical Pathology | 61 |
| 26 | BB | Blood Bank | 61 |
| 27 | BGL | Blood Gas Lab | 67 |
| 28 | CAR | Cardiology Services | 38 |
| 29 | CH | Chemistry | 61 |
| 30 | CR | Cardiac Rehab | 79 |
| 31 | CT | Computer Tomography | 55 |
| 32 | DTY | Dietary Services | 81 |
| 33 | ECG | Electrocardiogram | 63 |
| 34 | EEG | EEG | 66 |
| 35 | EMG | EMG | 77 |
| 36 | GS | Grant Square | 94 |
| 37 | HCS | Hema/Coag/Sero | 61 |
| 38 | MAM | Mammography | 54 |
| 39 | MCS | Microbio Cult/Sm | 61 |
| 40 | MON | Medical Oncology | 41 |
| 41 | MRI | Mag Resonance | 51 |
| 42 | NM | Nuclear Medicine | 56 |
| 43 | PT1 | PT Centers | 80 |
| 44 | RAD | Diagnostic Radiology | 52 |
| 45 | ST | Speech Therapy | 73 |
| 46 | US | Ultrasound | 57 |
| 47 | USC | Urine/Stool/CSF | 61 |
| 48 | VAS | Vascular Center | 76 |
| 49 | VIP | Vasc Intervent | 53 |
| | | Process | |
| 50 | NW | Nutritional Wellness | 90 |
| 51 | URO | UroDynanamics | 58 |
| 52 | DIAL | Dialysis | 85 |
| 53 | PT2 | LaGr Rehab | 0 |

### Appendix B

### Codes Assigned to Facility Areas and Departments

| Assigned Code Area | Area and |
|---|---|
| and Department Code | Department Name |
| 1 | Floor |
| 2 | Pharmacy |
| 3 | MS/CS Charges |
| 4 | Pulmonary |
| 5 | Outpatient |
| 6 | Other |

### Appendix C

### Primary Coding System—

### Codes that Track Financial Errors

| LETTER | TEXT DESCRIPTION |
|---|---|
| A | Item in room - on Kardex but not documented |
| | in the designated area in the medical record |
| B | Item indicated on the charge sheet but not |
| | supported by documentation in the designated |
| | area in the medical record |
| C | Item documented in the medical record but |
| | not marked on the charge/preference sheet |
| D | Time Calculation Error |
| E | Level Determination Error |
| F | Other |
| G | Item not “zeroed” out on the preference |
| | sheet and not supported by documentation in |
| | the medical record |
| H | Incorrect Item # Chosen |
| I | No Time Marked on Charge Sheet |
| J | Time Calculation AND Level Determination not |
| | indicated on OR Record |
| K | Quality Risk Management Issues/errors |
| L | Case Management issue |
| M | New item not indicated in charge master |
| N | Admitting/Registration Errors |
| O | Actual item incorrectly presented in charge |
| | master |
| P | Price evaluation |
| Q | Business office issues |
| R | Diagnosis & Procedure code issues |
| S | Medical Record Dept/Health Information |
| | Management Issues |
| T | VCM - Payor Financial Errors |
| U | VCM - Patient Financial Errors |
| V | VCM - Hospital Financial Errors |
| W | VCM - Physician Financial Errors |
| X | VCM - Allied Health Financial Errors |
| Y | VCM - Non-Traditional Financial Errors |
| Z | VCM - Other Business Financial Errors |

### Appendix D

### Secondary Coding System: Codes that Track Specific Items and Departments

| Letter | Text Description |
|---|---|
| P1 | Pump 1 chamber |
| P2 | Pump 2 chamber |
| K | Kaofeed tube |
| SCD | boots |
| Aqua | heating blanket |
| Gomco | suction machine |
| DS | Day surgery |
| TP | Temporary Pacemaker |
| IV | Intravenous access |
| CS | Conscious sedation |
| PS | Pulmonary Service |
| RX | Pharmacy |
| F2 | Department specific |
| MS | Material supply |
| AM | Apnea Monitor |
| CPM | Continuous Passive Motion Machine |
| WS | Wall Suction |
| BED | Specialty bed order |
| NC | No Charge |
| Glucose | acute check reading |
| HRR | High risk recovery |
| HTM | Hemodynamic monitoring |
| Dialysis | Dialysis treatment |
| HEMO | HEMO bed |
| OBG | Observation Patient |
| INP | Inpatient Status |
| AL | Arterial Line |
| AS | Arterial Sheath |
| ACT | Clotting test |
| O.C. | Pulse Ox Continuous |
| OR | Pulse Ox Random |
| TLC | Triple lumen catheter |
| VAS | Vascular catheter |
| SG | Swan Gand |
| PL | Peripheral line |
| AL | Arterial line |
| IAB | Balloon pump |
| CO | Cardiac Output |
| SVO2 | monitor |
| TP | Temporary Pacemaker |
| IS | Inline suction catheter |
| Code | arrest |
| scale | bed scale |
| Payor | VCM - Payor Department Errors |
| dpatient | VCM - Patient Department Errors |
| dhospital | VCM - Hospital Department Errors |
| dphysician | VCM - Physician Department Errors |
| dallied | VCM - Allied Health Department Errors |
| dnon | VCM - Non-Traditional Department Errors |
| dother | VCM - Other Business Department Errors |

### Appendix E

### Tertiary Coding System: Codes that Track Clinical Errors that Result In Clinical Case Management Referrals

| Letter | Text Description |
|---|---|
| AA1 | Incomplete documentation of services |
| AA2 | Incomplete documentation of medications |
| AA3 | Incomplete documentation of equipment |
| BB1 | Incomplete documentation of clinical |
| | outcomes |
| CC1 | Inconsistent documentation of patient |
| | services in comparison to MD order |
| CC2 | Inconsistent documentation of patient |
| | medication in comparison to MD order |
| CC3 | Inconsistent documentation of patent |
| | equipment in comparison to MD order |
| DD1 | Inconsistent execution of patient |
| | services in comparison to hospital P&P |
| DD2 | Inconsistent execution of patient |
| | medication in comparison to hospital |
| | P&P |
| DD3 | Inconsistent execution of patient |
| | equipment in comparison to hospital P&P |
| EE1 | Omitted or delayed service |
| EE2 | Omitted or delayed medication |
| EE3 | Omitted or delayed use of equipment |
| FF1 | Staffing issues |
| GG1 | Treatment of iratrogenic complications |
| GG2 | Death secondary to iratrogenic |
| | complication |
| HH1 | Missing critical documents: including |
| | and not limited to consents, H&P, |
| | admission profile, discharge profile |
| HH2 | Verbal orders not co-signed |
| HH3 | Missing MD signatures |
| II1 | staff: skill set issue |
| II2 | staff: impairment issue |
| JJ1 | Inventory issue |
| KK1 | Financial services referral |
| LL1 | Incorrect admission status |
| MM | VCM - Payor Clinical Errors |
| OO | VCM - Patient Clinical Errors |
| PP | VCM - Hospital Clinical Errors |
| QQ | VCM - Physician Clinical Errors |
| RR | VCM - Allied Health Clinical Errors |
| SS | VCM - Non-Traditional Clinical Errors |
| TT | VCM - Other Business Clinical Errors |

1. A method for training personnel to audit a business at a location wherein a transaction occurs at the location associated with the business, the method comprising the steps of:
choosing the personnel to audit the business at the location of the transaction;
training the personnel to collect data at the location of the transaction;
training the personnel to audit records as the records are created wherein the records are created by the transaction of the business; and
training the personnel to visually audit the transaction of the business.

2. The method of claim 1 further comprising the steps of:
training the personnel to audit records by comparison to sources for documenting the business; and
training the personnel to identify any irregular activity that is not documented.

3. The method of clam 1 further comprising the steps of:
training the personnel to evaluate the effectiveness of the audit of the business;
training the personnel to design efficient auditing procedures for the business;
training the personnel to communicate with clients;
training the personnel to conduct a retrospective analysis of the business; and
training the personnel to collect relevant data and enter data into a database.

4. The method of claim 1 further comprising the step of:
choosing at least one of a manager, an auditor, or a technologist as the personnel to audit at the location of the transaction.

5. The method of claim 1 further comprising the step of:
training the personnel to conduct transactions related to all services provided to a patient in a healthcare facility.

6. The method of claim 1 further comprising the step of:
training the personnel to collect data records related to the care of a patient at a healthcare facility and audit the records as the records are created.

7. The method of claim 1 further comprising the step of:
training the personnel to collect data records related to the care of a patient at a healthcare facility that include records related to the patient's medical condition and records that are not related to the patient's medical condition.
